(19) United States
(12) Patent Application Publication
(10) Pub. No.: US 2013/0214075 A1
(43) Pub. Date: Aug. 22, 2013

(54) TWO-SHAFT SHREDDER HAVING AN INTERCHANGEABLE CUTTING BLADE SET

(71) Applicants: Michael Abeln, Halen (DE); Markus Kolbeck, Steinfeld (DE)

(72) Inventors: Michael Abeln, Halen (DE); Markus Kolbeck, Steinfeld (DE)

(21) Appl. No.: 13/812,534

(22) PCT Filed: Jun. 27, 2011
(86) PCT No.: PCT/EP11/60703

§ 371 Date: Apr. 12, 2013

(30) Foreign Application Priority Data
Jul. 26, 2010 (DE) 202010010662.1

(51) Int. Cl. B02C 18/18; B23P 15/28

(52) U.S. Cl. CPC B02C 18/182; B23P 15/28
USPC 241/236; 241/297; 76/115

(57) ABSTRACT

The invention relates to a twin-shaft shredder for shredding solids or liquid-borne solids, comprising a casing, a first and a second shaft rotatably mounted in the casing, a plurality of first cutting disks on the first shaft, a plurality of second cutting disks on the second shaft, wherein the first and second cutting disks are axially offset relative to each other, at least some of the first cutting disks respectively engage in an interspace between two adjacent second cutting disks and some of the second cutting disks respectively engage in an interspace between two adjacent first cutting disks. According to the invention, the first and second cutting disks are designed as first and second cutting disk blocks, respectively, in that the cutting disks are respectively formed integrally on a first or second hub body comprising an axial bore which can be arranged around a section of the respective shaft and which is fixed torque-resistantly on the shaft, preferably by means of a positively interlocking shaft-hub-connection.

The invention relates to a twin-shaft shredder for shredding solids or liquid-borne solids, comprising a casing defining an inner shredding chamber, an inlet opening in the casing for feeding solids into the shredding chamber, an outlet opening in the casing for discharging shredded solids from the shredding chamber, a first shaft rotatably mounted in the casing and partially extending into or penetrating the shredding chamber, a second shaft rotatably mounted in the casing and partially extending into the shredding chamber and running parallel to the first shaft, a plurality of first cutting disks fixed torque-resistantly to the first shaft in such a way that an interspace is formed between each two adjacent first cutting disks, and a plurality of second cutting disks fixed torque-resistantly to the second shaft in such a way that an interspace is formed between each two adjacent second cutting disks, wherein the first and second cutting disks are axially offset relative to each other, at least some of the first cutting disks respectively engage in an interspace between two adjacent second cutting disks, and some of the second cutting disks respectively engage in an interspace between two adjacent first cutting disks.

Twin-shaft shredders of this design are used to shred or comminute solids, for example organic substances such as branches, twigs, plants and other materials, such as plastic waste. The solids to be shredded can be fed to the twin-shaft shredder in dried form or in a liquid stream through the inlet opening.

In order to shred efficiently, twin-shaft shredders have two shafts, on each of which a plurality of cutting disks are arranged. These cutting disks engage reciprocally with each other, which is made possible and achieved by two adjacent cutting disks on a shaft being spaced apart from each other by an axial distance that is greater than the thickness of a cutting disk of the other shaft, and by the axial spacing of the two shafts from each other being smaller than the diameter of a cutting disk.

The two shafts of a twin-shaft shredder are typically driven in opposite directions, and to that end are coupled to each other via an appropriate transmission, for example. Good shredding results are specifically achieved when the two shafts rotate at different speeds. In this way, strong shear forces and tensile forces are produced by the counter-rotating cutting disks in the interspace between the two shafts, which in turn results in efficient shredding. Different rotor speeds also cause different adjacent cutting disks to engage with each other on each revolution, as a result of which the cutting disks are automatically cleaned of any shredding material that might adhere to them.

The disadvantage of twin-shaft shredders of this constructional design is that, due to the manner in which the two shafts and the cutting disks arranged thereon, it is possible for individual cutting disks to be damaged when a hard solid body gets into the shredding chamber and is jammed between two cutting disks or between a cutting disk and the shaft opposite. A cutting disk can be seriously damaged in the region of its cutting edges, with the result that further operation of the twin-shaft shredder is no longer possible, or with only minimal shredding efficiency.

Fitting twin-shaft shredders with a quick-change system for that purpose, in which the cutting disks can be removed singly from the shafts in order to replace such a damaged cutting disk, are known from the prior art. Such systems allow the twin-shaft shredder to be restored to normal operation after brief maintenance and at low cost for spare parts.

Another disadvantage of prior art twin-shaft shredders is that, if a solid body is caught between two interleaved cutting disks or between a cutting disk and the shaft opposite it, this can give rise to a substantial amount of peak torque on these two cutting disks and/or on a cutting disk. These peak torque levels can cause a cutting disk that is torque-resistantly fixed to a shaft to be detached from the shaft. Such damage to the torque-resistant anchoring of a cutting disk on the shaft can render continued operation of the twin-shaft shredder impossible, or only possible with limited efficiency, and in particular with the risk of further damage being caused to other components of the twin-shaft shredder.

The object of the invention is to provide a twin-shaft shredder which avoids or at least reduces the aforementioned problems.

This object is achieved, according to the invention, by the first cutting disks being designed as first cutting disk block, wherein the first cutting disks are respectively formed integrally on a first hub body comprising an axial bore which can be arranged around a section of the first shaft and which is fixed torque-resistantly on the first shaft, preferably by means of a positively interlocking shaft-hub-connection, and the second cutting disks are designed as second cutting disk block, in that the second cutting disks are respectively formed integrally on a second hub body comprising an axial bore which can be arranged around a section of the second shaft and which is fixed torque-resistantly on the second shaft, preferably by means of a positively interlocking shaft-hub-connection.

The twin-shaft shredder according to the invention provides an advantageous construction of the cutting disk set. This improved construction consists in the cutting disks being integrally formed on a hub body. A monolithic cutting disk is formed as a result, in which all the cutting disks provided for a shaft are preferably integrally formed on a common hub body. This configuration may be implemented for one or for both of the two shafts.

One crucial advantage of the invention is that the cutting disks are now joined by a material fit to a hub body. This material fit can be achieved by the cutting disks and the hub body being made from a single starting material and consequently of such integral construction, or by the cutting disks being joined to the hub body in a material join using appropriate material joining techniques such as friction welding or other welding techniques, and thus being integrally formed. Due to this highly resilient join between the cutting disks and the hub body, and the possibility simultaneously provided of securing the hub body torque-resistantly to the shaft over a long axial portion of the shaft, the risk of a single cutting disks loosening as a result of a peak load induced by a hard solid body is decisively reduced. The twin-shaft shredder according to the invention is more efficient and robust as a result, and the service life of the cutting disks arranged thereon is longer on the whole. The twin-shaft shredder according to the invention also allows the integral cutting disk/hub body combination to be removed from the shaft in the event of damage nevertheless occurring to one or more cutting disks, and repairs to be carried out on it to restore functionality. Alternatively, the entire integral combination of cutting disks and hub body may also be replaced by a new intact part or replacement part.

The invention is based in this regard on the realisation that the risk of damage to a single cutting disk can be substantially reduced by integrally joining that cutting disk to a hub body that extends further in the axial direction than the cutting disk itself. This relieves the stress on the shaft-hub join, thus reducing the risk of damage to the torque-resistant anchoring of a single cutting disk on the shaft. The twin-shaft shredder according to the invention is able as a result to achieve higher-powered cutting without individual cutting blades being damaged in the region of their shaft-hub connection.

Another advantage that has been discovered is that replacing the integral combination of cutting disk and hub allows for easier installation than replacing single cutting disks in a twin-shaft shredder according to the prior art. More specifically, what the embodiment according to the invention achieves is that installation errors, for example when a wrong spacer sleeve is installed between two cutting disks, can be prevented, thus improving the operational reliability and ease of installation of the inventive twin-shaft shredder compared to the prior art.

Another advantage that ensues from producing the cutting disk block as an integral unit is that very small clearances can thus be provided between the reciprocally engaging cutting disks. One reason for this is that, by producing the cutting disk block from a single piece of material, it is possible to work with direct tolerances, whereas when a cutting blade set is composed of a plurality of single cutting disks and spacer sleeves therebetween, the tolerances for the cutting disks and spacer sleeves are additive, so larger clearances are required to ensure free running. Smaller clearances results in better cutting action on the part of the inventive twin-shaft shredder. Yet another advantage ensues from the fact that in many shredding scenarios, it is necessary to shred liquid-borne solids. In such cases it is desirable that the shredding chamber be sealed against the shaft. This seal is made substantially easier by designing the cutting blade set as a monolithic cutting disk block, since there are then only two sealing faces to be sealed, at the respective end faces of the cutting disk block. In contrast thereto, prior art cutting blade sets have many sealing faces between the respective cutting disks and spacer sleeves.

The hub body can be fixed torque-resistantly to the shaft by frictional engagement or force-lockingly, but it is preferred that a positively interlocking shaft-hub connection is used, for example in the form of a multi-tooth shaft, a spline shaft or a feather key connection between the hub body and the shaft. It is particularly advantageous in this regard when the torque-resistant shaft-hub connection extends over the entire axial longitudinal extension of the cutting disk block, or at least over a length that is more than half the axial length of the cutting disk block or which is larger at least than the width of a single cutting disks.

Compared to the prior art, this substantially increases the load capacity of the torque transmission between the cutting disk block and the shaft and reduces the risk of this shaft-hub connection failing. It should be understood, as a basic principle, that the hub body is detachably secured to the shaft so that the hub body can be removed from the shaft along with all the cutting disks integrally formed thereon.

According to a first preferred embodiment, the first and/or the second cutting disk block is machined, in that the first or second cutting disks and the first or second hub body are respectively machined from an integral metal block. With this variant of the inventive hub body-cutting disk combination, an efficiently produced construction in accordance with the invention is used. It should be understood in this regard that the plurality of cutting disks can be made from a cylindrical starting material having an outer diameter that is at least equal to the maximum outer diameter of a cutting disk. The interspace between single cutting disks is produced by machining, followed or preceded by machining the cutting and shredding tools on the outer circumference of each cutting disk by respective machining in the axial direction.

According to another preferred embodiment, the axial width of the interspace between two adjacent cutting disks is constant in the radial direction. This embodiment allows a cutting blade with a constant axial width in the radial direction to engage in the interspace between two adjacent cutting disks and that uniformly running gaps are formed between the cutting disk engaging in the interspace and the walls of the cutting disks defining the interspace.

It is still further preferred that a plurality of cutting elements fixed detachably to a corresponding plurality of cutting element receptacles be arranged on the outer circumference of each cutting disk. In this embodiment, it is possible, for example, that the cutting elements are designed as alternating cutting plates that are replaceable and which can be fastened to the cutting disk by means of a screw connection. This allows blunt or damaged cutting elements to be replaced, thus avoiding the entire cutting disk block having to be replaced due to wear and tear or damage.

According to another preferred embodiment, a plurality of cutting elements integrally connected to the cutting disk are arranged on the outer circumference of each cutting disk. This embodiment is an advantageous design from the production engineering perspective, can be produced cost-efficiently and is suitable for many shredding tasks.

It is still further preferred that a plurality of cutting elements be arranged on the outer circumference of each cutting disk, and that the cutting elements of the cutting disks of a cutting disk block run along a helical line of a single or multi-start thread. In this way, the cutting elements are embodied as one or more rows along the outer circumference of the cutting disk block, wherein the helical line may be designed with a large pitch with an almost axial orientation. The offset thus achieved between the cutting elements prevents the cutting elements of adjacent cutting disks from simultaneously contacting a solid to be shredded that has come to lie parallel to the axis of rotation, thus causing a dynamic peak load on all the cutting disks of the cutting disk block. Instead, the cutting elements arranged along a helical line engage each other successively by rotation of the cutting disk block, thus producing a continuous cutting force. More particularly, a cutting element of a first helical line may be positioned at approximately the same level as a cutting blade of an adjacent helical line at the other end of the cutting disk block.

It is still further preferred that a plurality of cutting elements be arranged on the outer circumference of each cutting disk, that the cutting elements of the cutting disks of the first and the second cutting disk run along a helical line of a single or multi-start thread and that the first and second cutting disk block be respectively mounted on the first and second shaft in such a way that the helical line of the thread of the first cutting disk block is left-handed and the helical line of the thread of the second cutting disk block is right-handed. This design of the cutting disk block and its arrangement results in the helical cutting elements intermeshing like a helical gear, which in turn prevents peak loads being caused by solids lying parallel to the axis of rotation and caught by the cutting elements.

According to the invention, the cutting elements or cutting points on the respective cutting disks are hardened by a hardening process, whereas the rest of the cutting disks and the hub are not subjected to such hardening and remain tough and elastic. This increases the wear resistance of the cutting elements involved in shredding, yet retain the insensitivity to shock loads imposed on the cutting disk block, since the latter can respond to shock loads with elastic or even plastic deformation due to the toughness of the material.

According to another preferred embodiment, finally, the first and the second cutting disk block are structurally identical in respect of the axial positioning of the blades, with the structure of each cutting disk block beginning at a respective first end with a hub shoulder, followed axially by a cutting disk and by additional cutting disks spaced apart from each other by an interspace, and ending with a cutting disk at a second end, and the first and second cutting disk block being mounted in the shredding chamber in such a way that first end of the first cutting disk block is arranged radially opposite the second end of the second cutting disk block and the second end of the first cutting disk block is arranged radially opposite the first end of the second cutting disk block. This development of the invention allows the first and second cutting disk block to be advantageously produced in a uniform manner with regard to numerous specific production steps and then, by installing the first cutting disk block mirror-invertedly in relation to the second cutting disk block, that the cutting disks of the first cutting disk block engage in the interspace of the second cutting disk block and vice versa. This makes it easier to produce and to keep stocks of prefabricated cutting disk blocks, and also allows cutting disk blocks kept in stock to be universally deployed at the customer. Producing the cutting disk blocks in a uniform manner also allows their production costs to be reduced.

Another aspect of the invention involves a cutting blade set for a twin-shaft shredder of the previously described construction, characterise in that the cutting blade set is designed as a cutting disk block, in that a plurality of cutting disks is integrally formed on a hub body comprising an axial bore adapted to be fixed torque-resistantly to a shaft, preferably by means of a positively interlocking shaft-hub-connection. This cutting blade set can be used, in particular, to retrofit existing twin-shaft shredders with the advantageous cutting disk block according to the invention and can also be used as a spare part for cutting disk blocks with the constructional design according to the invention.

The cutting blade set according to the invention can be further developed in the same way as previously described for the cutting disk block installed in the twin-shaft shredder.

Another, final, aspect of the invention is a process for manufacturing a cutting blades set for a twin-shaft shredder with the constructional design described above, the process comprising the following steps: providing a semi-finished product, the length of which is at least equal to the length of the set of cutting blades and which surrounds the desired contour of the cutting blade set, at the least as an enclosing end, machining the semi-finished product to produce an axial longitudinal bore and a feather key slot in said longitudinal bore, machining the semi-finished product to produce axial interspaces between two adjacent cutting disks, and machining the semi-finished product to produce cutting elements on the circumferential surfaces of the cutting disks.

This method is a particularly efficient way of manufacturing an easily installed cutting blade set for a twin-shaft shredder, while simultaneously endowing the cutting blade set with greater resilience against peak loads imposed by hard solids on individual cutting blades.

Preferred embodiments of the invention shall now be described with reference to the attached Figures, in which:

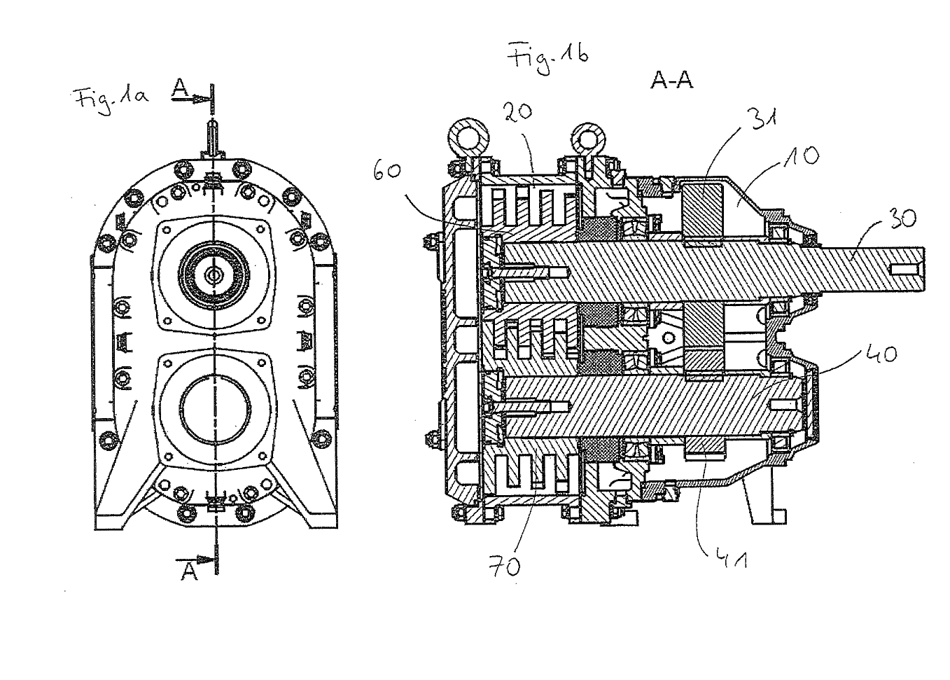

FIG. 1b shows a side cross-sectional view of a twin-shaft shredder, with cutting disk blocks installed therein, along the line A-A shown in FIG. 1a,

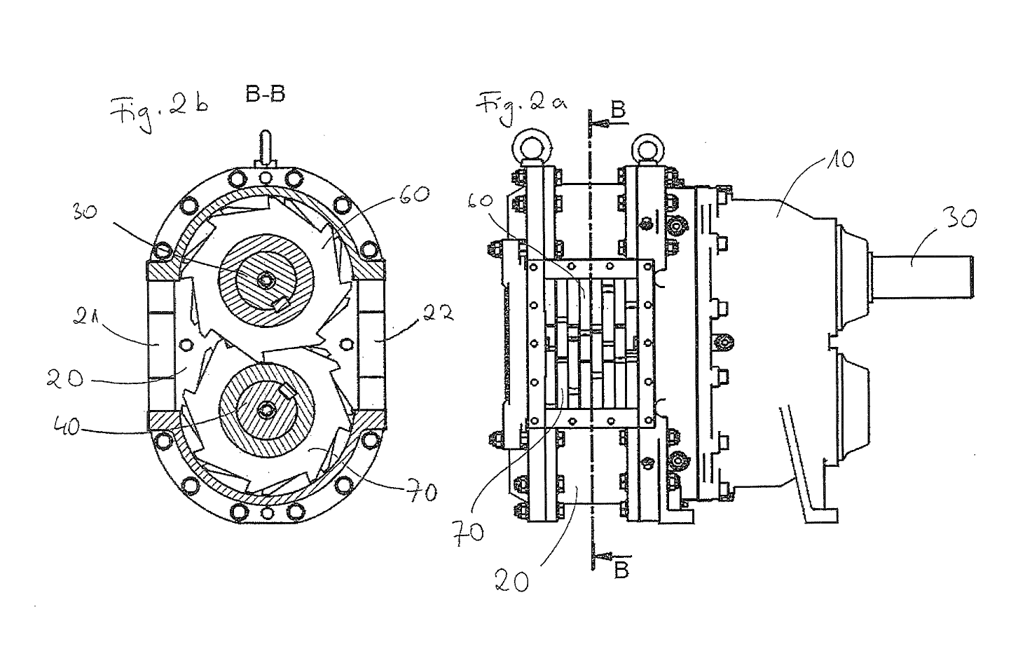

FIG. 2b shows a front cutaway view of a twin-shaft shredder with cutting disk blocks installed therein, along the line B-B shown in FIG. 2a,

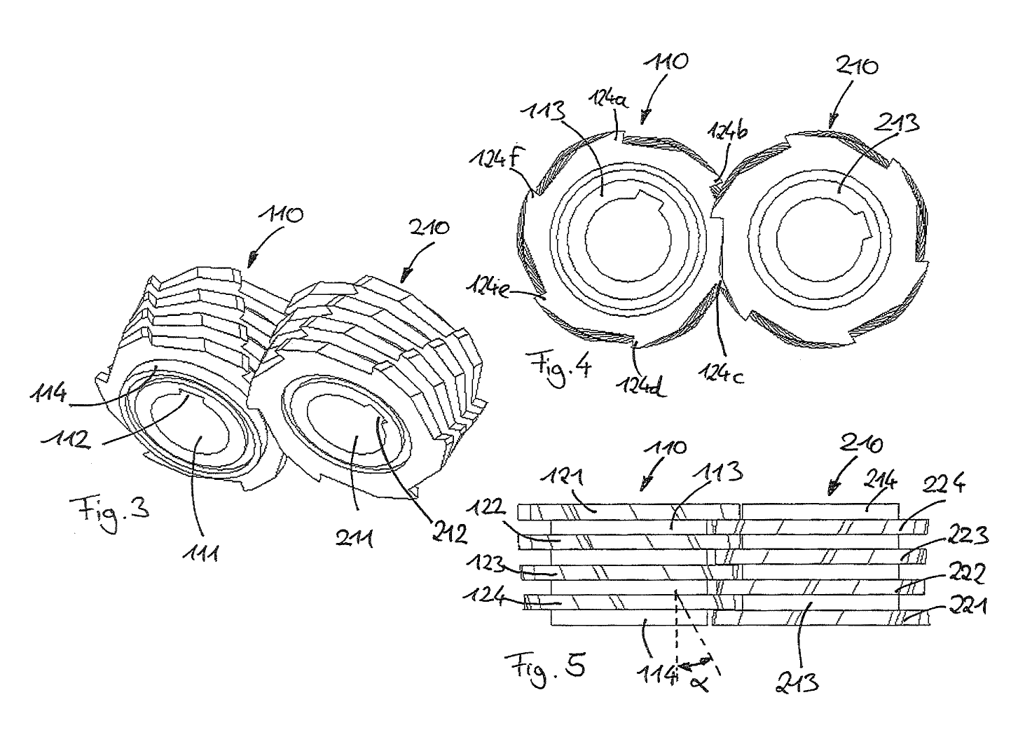

FIG. 3 shows a perspective plan view of two cutting disk blocks according to the invention, in an assembled arrangement,

FIG. 4 shows a front view of the cutting disk blocks in FIG. 3, and

FIG. 5 shows a side view of the cutting disk blocks in FIG. 3.

FIGS. 1 and 2 show a longitudinal section and a cross-section through a twin-shaft shredder according to the invention. As can be seen, the twin-shaft shredder is subdivided into a gear chamber 10 and a shredding chamber 20, the two chambers being sealed from each other. In the region between the gear chamber and the shredding chamber, two shafts 30, 40 are rotatably mounted inside a casing of the shredder.

Shafts 30, 40 extend into shredding chamber 20. It should be understood, as a basic principle, that the shafts may also be likewise mounted in a cover that closes the shredding chamber 20 on the side facing away from the gear chamber.

Shredding chamber 20 has an inlet opening and an outlet opening 21, 22, through which solids, or liquids loaded with solids, can be fed to and/or discharged from the shredding chamber.

Inside the shredding chamber, a first cutting disk block 60 and a second cutting disk block 70 are fixed torque-resistantly to shafts 30, 40.

The two shafts 30, 40 rotate at different speeds, such that different adjacent cutting disks of the two cutting disk blocks 60, 70 engage with each other on each revolution, as a result of which the cutting disks are automatically cleaned of any shredding material that might adhere to them. To that end, the gear wheels 31, 41 arranged on shafts 30, 40 have different diameters.

The cutting disk block shall now be explained with reference to FIGS. 3-5 that follow.

A gear mechanism comprising two gear wheels having different numbers of teeth which are fixed directly and torque-resistantly on the shafts and which intermesh with each other is arranged in the gear chamber. As a result of this arrangement, the two shafts 30, 40 are made to rotate in opposite directions and at different speeds. One of the two shafts is guided out of the casing and can be made to rotate by means of a drive motor. This rotation is transmitted by the gear mechanism to the other shaft.

FIGS. 3-5 show two cutting disk blocks 110, 210 having the construction according to the invention. As can be seen, both cutting disk blocks 110, 120 have an axial longitudinal bore 111, 211 which is used to allow each cutting disk block to be pushed onto a respective shaft of the twin-shaft shredder. An axial groove 112, 212 which can receive a feather key inserted in a matching axial groove of the shaft is disposed in longitudinal bore 111, 211 to produce a positively interlocking shaft-hub connection between the cutting blade blocks and the shaft.

Each cutting disk block 110, 210 has a total of four cutting blades 121-124 and 221-224, respectively, which are integrally formed with a hub body 113, 213.

On the circumference of each cutting disk, six cutting elements 124a-f evenly distributed in the circumferential direction are formed. The cutting elements form helical lines of a six-start thread having a steep gradient along the circumference of the cutting disk block. The cutting elements of cutting disk block 110 form a left-handed thread, whereas the cutting elements of the cutting disk block 210 form a right-handed thread.

As can be seen, the front end of cutting disk block 110 is provided with a shoulder 114, whereas the front end of cutting disk block 210 begins with a cutting disk 221. Cutting disk 221 engages in the axial space formed by shoulder 114. A shoulder 214 is correspondingly formed on the rear end of cutting disk block 210, and cutting blade 121 on the rear end of cutting disk block 110 engages in the space provided by said shoulder 214. All the other cutting blades engage in a respective interspace between two adjacent cutting blades of the opposite cutting disk block.

It should be understood, as a basic principle, that cutting disk block 110 and cutting disk block 210 are each formed of a single semi-finished starting product, wherein a preferably cylindrical semi-finished starting product is machined accordingly in order to form the interspace, the axial bore and the cutting elements from said semi-finished starting product.

As can also be seen from FIG. 5 in particular, the cutting elements are formed on the cutting disks with a clearance angle a. Due to the this clearance angle a to the longitudinal axis of the cutting disk block, the cutting effect of the twin-shaft shredder is further increased.

1. A twin-shaft shredder for shredding solids or liquid-borne solids, comprising
a casing which defines an inner shredding chamber,
an inlet opening in the case for feeding solids into the shredding chamber,
an outlet opening in the case for discharging shredded solids from the shredding chamber,
a first shaft rotatably mounted in the casing and partially extending into or penetrating the shredding chamber,
a second shaft rotatably mounted in the casing and partially extending into the shredding chamber and running parallel to the first shaft,
a plurality of first cutting disks fixed torque-resistantly to the first shaft in such a way that an interspace is formed between each two adjacent first cutting disks,
a plurality of second cutting disks fixed torque-resistantly to the second shaft in such a way that an interspace is formed between each two adjacent second cutting disks, wherein the first and second cutting disks are axially offset relative to each other, at least some of the first cutting disks respectively engage in an interspace between two adjacent second cutting disks and some of the second cutting disks respectively engage in an interspace between two adjacent first cutting disks,
characterised in that
the first cutting disks are designed as a first cutting disk block, in that the first cutting disks are integrally moulded on a first hub body which
has an axial bore which can be arranged around a section of the first shaft and
which is fixed torque-resistantly to the first shaft, preferably by means of a positively interlocking shaft-hub connection, and in that the second cutting disks are designed as a second cutting disk block, in that the second cutting disks are integrally moulded on a second hub body, which
has an axial bore which can be arranged around a section of the second shaft and
which is fixed torque-resistantly to the second shaft, preferably by means of a positively interlocking shaft-hub connection.

2. The twin-shaft shredder according to claim 1, characterised in that the first and/or the second cutting disk block is machined, in that the first or second cutting disks and the first or second hub body are respectively machined from an integral metal block.

3. The twin-shaft shredder according to claim 1 or 2, characterised in that the interspace between two adjacent cutting disks is constant in the radial direction.

4. The twin-shaft shredder according to any one of the preceding claims, characterised in that a plurality of cutting elements fixed detachably to a corresponding plurality of cutting element receptacles are arranged on the outer circumference of each cutting disk.

5. The twin-shaft shredder according to any one of the preceding claims 1 to 3, characterised in that a plurality of cutting elements integrally connected to the cutting disk are arranged on the outer circumference of each cutting disk.

6. The twin-shaft shredder according to any one of the preceding claims, characterised in that a plurality of cutting elements is arranged on the outer circumference of each cutting disk, and the cutting elements of the cutting disks of a cutting disk block run along a helical line of a single or multi-start thread.

7. The twin-shaft shredder according to any one of the preceding claims, characterised in that a plurality of cutting elements are arranged on the outer circumference of each cutting disk, the cutting elements of the cutting disks of the first and the second cutting disk run along a helical line of a single or multi-start thread and the first and second cutting disk block are respectively mounted on the first and second shaft in such a way that the helical line of the thread of the first cutting disk block is left-handed and the helical line of the thread of the second cutting disk block is right-handed.

8. The twin-shaft shredder according to any one of the preceding claims, characterised in that
the first and the second cutting disk blocks are structurally identical,
the structure of each cutting disk block begins at a respective first end with a hub shoulder, followed axially by a cutting disk and by additional cutting disks spaced apart from each other by an interspace, and ending with a cutting disk at a second end, and
the first and second cutting disk block are mounted in the shredding chamber in such a way that
the first end of the first cutting disk block is arranged radially opposite the second end of the second cutting disk block and
the second end of the first cutting disk block is arranged radially opposite the first end of the second cutting disk block.

9. A cutting blade set for a twin-shaft shredder according to any one of the preceding claims 1 to 8,
characterised in that the cutting blade set is designed as a cutting disk block, in that a plurality of cutting disks is integrally formed on a hub body comprising an axial bore adapted to be fixed torque-resistantly to a shaft, preferably by means of a positively interlocking shaft-hub-connection.

10. The cutting blade set according to claim 9, characterised in that the cutting disk block is developed according to any one of the preceding claims 2 to 6.

11. A process for manufacturing a cutting blade set for a twin-shaft shredder according to any one of the preceding claims 1 to 8, characterised by the steps of:
providing a semi-finished product, the length of which is at least equal to the length of the cutting blade set and which surrounds the desired contour of the cutting blade set, at the least as an enclosing end,
machining the semi-finished product to produce an axial longitudinal bore and a feather key slot in said longitudinal bore,
machining the semi-finished product to produce axial interspaces between two adjacent cutting disks,
machining the semi-finished product to produce cutting elements on the circumferential surfaces of the cutting disks.
